(19) United States
(12) Patent Application Publication
(10) Pub. No.: US 2025/0125658 A1
(43) Pub. Date: Apr. 17, 2025

(54) SWITCHGEAR WITH CONTACTLESS POWER TRANSMISSION SYSTEM FOR A TANK SENSOR

(71) Applicant: EATON INTELLIGENT POWER LIMITED, Dublin (IE)

(72) Inventors: Mangesh PINGLE, Pune (IN); Yogesh Suresh RAJWADE, Pune (IN)

(21) Appl. No.: 18/728,507

(22) PCT Filed: May 18, 2023
(86) PCT No.: PCT/EP2023/063431

§ 371 Date: Jul. 12, 2024

(30) Foreign Application Priority Data
May 25, 2022 (IN) 202211029970
Jul. 20, 2022 (GB) 2210636.3

(51) Int. Cl. H02J 50/10; H02B 13/035

(52) U.S. Cl. CPC H02J 50/10; H02B 13/035

(57) ABSTRACT

Some embodiments relate to a switchgear is disclosed, which comprises a tank system filled with an insulating gas and a switching device and at least one electronic sensor within the tank system. Moreover, the switchgear comprises a contactless power transmission system with a power transmitter outside of the tank system and with a power receiver within the tank system, wherein the power receiver is coupled to the power transmitter. Further on, the power receiver is electrically connected to the electronic sensor and designed to supply electric power to the same.

### CROSS-REFERENCE TO RELATED APPLICATIONS

This application is a national phase filing under 35 C.F.R. § 371 of and claims priority to PCT Patent Application No. PCT/EP2023/063431, filed on May 18, 2023, the content of which is hereby incorporated in its entireties by reference.

### TECHNICAL FIELD

The present disclosure relates to a switchgear, comprising a tank system filled with an insulating gas and comprising a switching device and at least one electronic sensor within the tank system.

### BACKGROUND ART

Such a switchgear is generally known in prior art. A pressure or temperature sensor may be arranged in a tank system for measuring pressure or temperature of the insulating gas within the tank system. For example, the insulating gas may consist of or comprise Sulfur hexafluoride (SF6). Over time, the gas filling may leak from the tank system so that the insulating function may decrease. To ensure a minimum of the insulating function, e.g. for the switching devices arranged within the gas filled system, a minimum pressure value of the gas filling can be defined. Once the pressure of the gas filling drops below this minimum pressure value, operation of the electrical switchgear can get dangerous. That is why it is advisable to stop the operation of the electrical switchgear in such a situation.

A drawback of prior art solutions is that the electronic sensor and a measuring unit are powered by electric wires lead through the wall of the tank system. Even if this penetration of the tank system is carefully sealed, this section of the tank system is particularly critical in terms of gas leakage. The reason is that tank systems and in particular tank systems of switchgears get a lifetime gas filling which shall be kept in the tank system over many years or even decades. For example, a common nominal lifetime of a switchgear is about 30 years.

### SUMMARY OF THE DISCLOSURE

Accordingly, an object of the presently disclosed subject matter is the provision of an improved switchgear. In particular, a solution shall be provided, which overcomes the drawbacks mentioned hereinbefore and provides air-tightness over a long period of time, in particular over the whole lifetime of a switchgear.

The object of the presently disclosed subject matter is solved by an switchgear as disclosed in the opening paragraph, which additionally comprises a contactless power transmission system with a power transmitter outside of the tank system and with a power receiver within the tank system, wherein
the power transmitter is designed to receive electric power from a power source and to convert it into an electrically non-conductive form of power,
the power receiver is coupled to the power transmitter and designed to receive the electrically non-conductive form of power from the power transmitter and designed to convert it into electric power and wherein
the power receiver is electrically connected to the electronic sensor and designed to supply electric power to the same.

By means of the inventive measures, air-tightness of a tank system is substantially improved because a lead through for powering the electronic sensor within the tank system can be saved. Accordingly, the risk for a gas leakage can substantially be decreased. Hence, the gas filling can be kept within the tank system over a long period of time, in particular over the whole lifetime of a switchgear.

Generally, the at least one electronic sensor can be a pressure sensor, a temperature sensor or a combined pressure and temperature sensor and hence can be designed to measure pressure and/or temperature. For example, the pressure sensor may be embodied as a capacitive pressure sensor.

It should be noted that a “tank system” can consist of or comprise a tank. Additionally, a “tank system” may also comprise tubes and the like. Accordingly, the electronic sensor can be arranged in a tank but also in a tube for example. In particular, the tank system is a hermetically sealed tank system in the context of the presently disclosed subject matter. The tank system can be filled with sulfur hexafluoride (“SF6” for short). Moreover, the tank system can be made of or comprises stainless steel or mild steel.

Further advantageous embodiments are disclosed in the claims and in the description as well as in the figures.

In a beneficial embodiment, the power transmitter can be designed as electromagnetic power transmitter and the power receiver can be designed as electromagnetic power receiver. In this case, the electrically non-conductive form of power is electromagnetic power, and the electromagnetic power transmitter and the electromagnetic power receiver are electromagnetically coupled. In particular, the electromagnetic power transmitter can comprise a power transmitter primary magnetic core and a primary power coil wound around the power transmitter primary core. Similarly, the electromagnetic power receiver can comprise a power transmitter secondary magnetic core and a secondary power coil wound around the power transmitter secondary magnetic core, wherein the electronic sensor is connected to the secondary power coil. In this embodiment the contactless power transmission system basically is embodied as a transformer, wherein the primary side is connected to a power source outside of the tank system and wherein the secondary side is arranged within the tank system to power the electronic sensor. In particular, a rectifier can be arranged between the secondary coil and the electronic sensor. Advantageously, a transformer is a well suited device to transmit electric energy in a contactless way.

“Electromagnetically coupled” in the context of this disclosure in particular is meant as “inductively coupled” or “substantially inductively coupled”. Accordingly, an electromagnetic field for transmission of power and/or data generally is generated and received by coils then. A frequency of the electromagnetic field in particular can be in the Hz and KHz range. In yet another preferred embodiment, resonant inductive coupling may be used for the concerns of the inventive problem.

In another beneficial embodiment, the power transmitter can be designed as an acoustic power transmitter (or sound emitter respectively) and the power receiver can be designed as acoustic power receiver (or sound receiver respectively). In this case, the electrically non-conductive form of power is acoustic power, and the acoustic power transmitter and the acoustic power receiver are acoustically coupled. Advantageously, an acoustic power transmitter is well suitable for tank systems made of steel and in particular mild steel because no electromagnetic fields, which could be influenced by the material of the tank system, are involved in power transmission. Acoustic power transmission can take place in the audible frequency range or advantageously in the ultrasonic frequency range. The latter provides power transmission without generation and emission of disturbing audible noise.

In yet another beneficial embodiment, the switchgear can comprise a contactless data transmission system with a data transmitter within the tank system and with a data receiver outside of the tank system as well as a microcontroller with a microcontroller input and a microcontroller output. In this case, the microcontroller is connected to the electronic sensor and designed to receive measurement data from the electronic sensor via its microcontroller input. The microcontroller output is connected to the data transmitter. The microcontroller is designed to send measurement data to the data transmitter via its microcontroller output, and the data receiver is designed to receive measurement data from the data transmitter in a contactless way. The microcontroller can comprise a processor and can comprise an on-board memory or can be connected to an external memory. By the proposed measures, air-tightness of a tank system can further be improved because a lead through for a data transmission system is not necessary either. Accordingly, the proposed data transmission system does not raise a risk for a gas leakage and helps to keep the gas filling within the tank system over a long period of time.

It is advantageous if the data transmitter comprises a radio data transmitter with a transmitter antenna and the data receiver comprises a radio data receiver with a receiver antenna. Advantageously, radio data transmission is a well suited method to transmit data in a contactless way, i.e. “over the air”.

“Radio data transmission” in the context of the presently disclosed subject matter relates to data communication via radio waves, which are generated and received by use of antennas. A frequency of the radio waves in particular can be in the MHz and GHz range.

In another advantageous embodiment, the data transmitter can be embodied as an electromagnetic data transmitter, and the data receiver can be an electromagnetic data receiver, wherein the electromagnetic data transmitter and the electromagnetic data receiver are electromagnetically coupled. In particular, the electromagnetic data transmitter can comprise a data transmitter primary magnetic core and a primary data coil wound around the data transmitter primary magnetic core. Similarly, the electromagnetic data receiver can comprise a data transmitter secondary magnetic core and a secondary data coil wound around the data transmitter secondary magnetic core, wherein the microcontroller output is connected to the secondary data coil. In particular, an evaluation unit can be connected to the secondary coil. Advantageously, a transformer is also a well suited device to transmit electric data in a contactless way.

In yet another advantageous embodiment, the data transmitter can be an acoustic data transmitter, and the data receiver can be an acoustic data receiver, wherein the acoustic data transmitter and the acoustic data receiver are acoustically coupled. Advantageously, an acoustic data transmitter is well suitable for tank systems made of steel and in particular mild steel because no electromagnetic fields, which could be influenced by the material of the tank system, are involved in data transmission. Acoustic data transmission can take place in the audible frequency range or advantageously in particular in the ultrasonic frequency range. The latter provides data transmission without generation and emission of disturbing audible noise.

It is also very advantageous if the switchgear comprises load modulation means connected to the electromagnetic power receiver, current sensing means connected to the electromagnetic power transmitter and a microcontroller with a microcontroller input and a microcontroller output. In this embodiment, the microcontroller is connected to the electronic sensor and designed to receive measurement data from the electronic sensor via its microcontroller input. The microcontroller output is connected to the load modulation means, and the microcontroller is designed to send measurement data to the load modulation means via its microcontroller output. Finally, the current sensing means are designed to receive measurement data from the electromagnetic power receiver. Again, the microcontroller can comprise a processor and can comprise an on-board memory or can be connected to an external memory. In one embodiment, the load modulation means can be formed by or comprise a series connection of a resistor and switch, which series connection is connected in parallel with the electromagnetic power receiver, for example connected in parallel with a secondary power coil of the electromagnetic power receiver. In this embodiment, the microcontroller output is provided to control the switch and thus the load on the secondary side. If the switch is opened and closed in accordance with binary data, the load fluctuations, which can also be sensed on the primary side by the current sensing means, represent said binary data. In this way, measurement data can be transmitted from the secondary side of the electromagnetic power transmitter to its primary side. Hence, strictly speaking, the electromagnetic power transmitter is not only a power transmitter but a combined electromagnetic power and data transmitter. For example, an evaluation unit can be connected to an output of the current sensing means and demodulate measurement data.

In a very advantageous embodiment of the switchgear,
the power transmitter is designed as electromagnetic power transmitter and the power receiver is designed as electromagnetic power receiver,
the electrically non-conductive form of power is electromagnetic power and
the electromagnetic power transmitter and the electromagnetic power receiver are electromagnetically coupled and
   a) the data transmitter comprises a radio data transmitter with a transmitter antenna and the data receiver comprises a radio data receiver with a receiver antenna or
   b) the data transmitter is an acoustic data transmitter and the data receiver is an acoustic data receiver, wherein the acoustic data transmitter and the acoustic data receiver are acoustically coupled.

This is an example for a mixed embodiment using different technologies based on different physical laws for power and data transmission. Hence, advantageously, power transmission and data transmission do not interfere.

In yet another very advantageous embodiment of the switchgear,
the power transmitter is designed as an acoustic power transmitter and the power receiver is designed as acoustic power receiver,
the electrically non-conductive form of power is acoustic power and
the acoustic power transmitter and the acoustic power receiver are acoustically coupled and
   c) the data transmitter comprises a radio data transmitter with a transmitter antenna and the data receiver comprises a radio data receiver with a receiver antenna or
   d) the data transmitter is embodied as an electromagnetic data transmitter and the data receiver is an electromagnetic data receiver, wherein the electromagnetic data transmitter and the electromagnetic data receiver are electromagnetically coupled.

This is another example for a mixed embodiment where different technologies based on different physical laws are used for power and data transmission. Hence, advantageously, power transmission and data transmission do not interfere.

It is particularly advantageous if the tank system is made of plastics in the region of the contactless power transmission system (and in the region of the optional contactless data transmission system as the case may be). The proposed measures help to increase efficiency of contactless power and/or data transmission systems based on electromagnetic coupling because plastics are almost “invisible” for electromagnetic power and/or data coupling, meaning that plastics do not substantially attenuate electromagnetic transmission. The very same counts for radio data transmission systems. However, advantages may also result when acoustic power and/or data transmission systems are used because plastics usually are substantially softer than metals what supports efficient transmission of acoustic energy through the wall of the tank system.

### BRIEF DESCRIPTION OF DRAWINGS

The presently disclosed subject matter now is described in more detail hereinafter with reference to particular embodiments, which the presently disclosed subject matter however is not limited to.

FIG. 1 shows a schematic view of a general example of a switchgear;

FIG. 2 shows a schematic view of a switchgear with an electromagnetic power transmission system and a radio data transmission system;

FIG. 3 shows a schematic view of a switchgear with an acoustic power transmission system and a radio data transmission system;

FIG. 4 shows a schematic view of a switchgear with an electromagnetic power transmission system and an electromagnetic data transmission system;

FIG. 5 shows a schematic view of a switchgear with an acoustic power transmission system and an acoustic data transmission system;

FIG. 6 shows a schematic view of a switchgear with a mixed power and data transmission system;

FIG. 7 shows a schematic view of a switchgear with load modulation means and

FIG. 8 shows a schematic view of a switchgear with a plastic housing section in the region of the power transmission system and data transmission system.

### DETAILED DESCRIPTION

Generally, same parts or similar parts are denoted with the same/similar names and reference signs. The features disclosed in the description apply to parts with the same/similar names respectively reference signs. Indicating the orientation and relative position is related to the associated figure, and indication of the orientation and/or relative position has to be amended in different figures accordingly as the case may be.

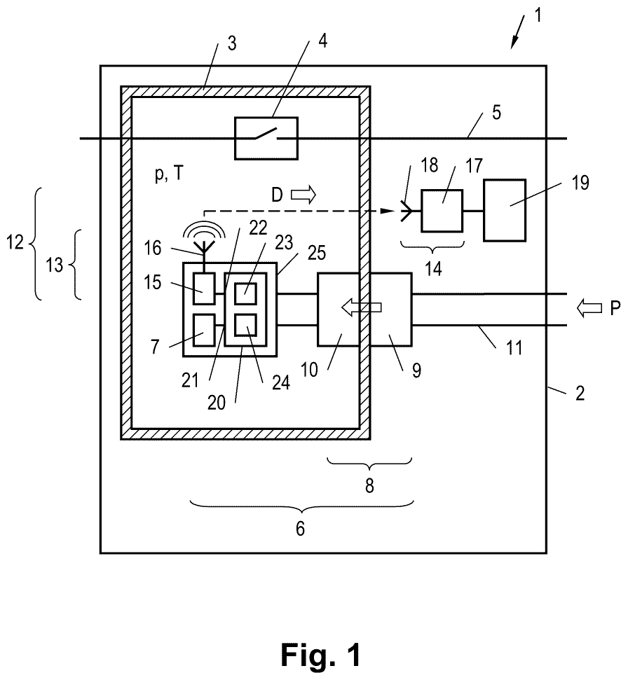

FIG. 1 shows a schematic view of a general example of a switchgear 1, which comprises a switchgear housing 2, a tank system 3 within the switchgear housing 2 and a switching device 4 arranged in within the tank system 3 which is connected to first power lines 5. The tank system 3 is filled with an insulating gas like sulfur hexafluoride (“SF6” for short). Accordingly, the insulating function within the tank system 3 is improved so that a proper function of the switching device 4 can be guaranteed.

Further on, the switchgear 1 comprises a first example of an arrangement 6 with at least one electronic sensor 7 within the tank system 3 and with a contactless power transmission system 8. The contactless power transmission system 8 has a power transmitter 9 outside of the tank system 3 and a power receiver 10 within the tank system 3. The power transmitter 9 is designed to receive electric power P from a power source and to convert it into an electrically non-conductive form of power. The power source is outside of the switchgear 1 in the example of FIG. 1 and hence not shown in FIG. 1, and electric power P is fed to the power transmitter 9 from outside via second power lines 11. The power receiver 10 is coupled to the power transmitter 9 and designed to receive the electrically non-conductive form of power from the power transmitter 9 and designed to convert it into electric power. Further on, the power receiver 10 is electrically connected to the electronic sensor 7 and designed to supply electric power to the same.

The at least one electronic sensor 7 can be designed to measure pressure p and/or temperature T of the insulating gas in the tank system 3. For example, the electronic sensor 7 may be embodied as a capacitive pressure sensor.

The arrangement 6 can also comprise an optional contactless data transmission system 12 with a data transmitter 13 within the tank system 3 and with a data receiver 14 outside of the tank system 3. In this example, the data transmitter 13 is a radio data transmitter 15 with a transmitter antenna 16, and the data receiver 14 is a radio data receiver 17 with a receiver antenna 18. The data receiver 14 is designed to receive measurement data D from the data transmitter 13 in a contactless way. The data receiver 14, in particular the radio data receiver 17, can be connected to an evaluation unit 19 like this is the case in FIG. 1.

Further on, the arrangement 6 can comprise a microcontroller 20 with a microcontroller input 21 and a microcontroller output 22, wherein the microcontroller 20 is connected to the electronic sensor 7 and designed to receive measurement data D from the electronic sensor 7 via its microcontroller input 21 and wherein the microcontroller output 22 is connected to the data transmitter 13, in particular to the radio data transmitter 15, and wherein the microcontroller 20 is designed to send measurement data to the data transmitter 13 via its microcontroller output 22. The microcontroller 20 can comprise a processor 23 and can comprise an on-board memory 24 like this is the case in FIG. 1. Alternatively, the microcontroller 20 or processor 23 can be connected to an external memory.

The electronic sensor 7, the data transmitter 13 and the microcontroller 20 form a sensing unit 25 connected to the power receiver 10 in this example.

The function of the switchgear 1 now is as follows:

As is generally known, a switching device 4 in an insulating gas can be used in mid voltage and high voltage switching applications. To ensure a minimum of the insulating function, the pressure value of the gas filling can be monitored. For this reason, the measuring unit 25 may permanently be powered or may be powered from time to time to measure the pressure p and/or the temperature T within the tank system 3 on a regular basis. As explained above, for this reason, electric power P is transmitted to the measuring unit 25 in a contactless way via the contactless power transmission system 8. The microcontroller 20 can control the electronic sensor 7 and gather measurement data D from the electronic sensor 7. It also passes the measurement data D over to the radio data transmitter 15, either with previous processing of the measurement data D or without such processing. The microcontroller 20 may also store measurement data D in the memory 24. Further on, the memory 24 may store a program, which is executed by the processor 23. Once the measurement data D is sent via the contactless data transmission system 12, the measurement data D can further be processed in the evaluation unit 19 and/or sent to a superordinate control by wire or wirelessly. It should be noted that the arrangement 6 may also comprise a driver stage between the microcontroller output 22 and data transmitter 15 if the microcontroller 20 cannot directly drive the data transmitter 15.

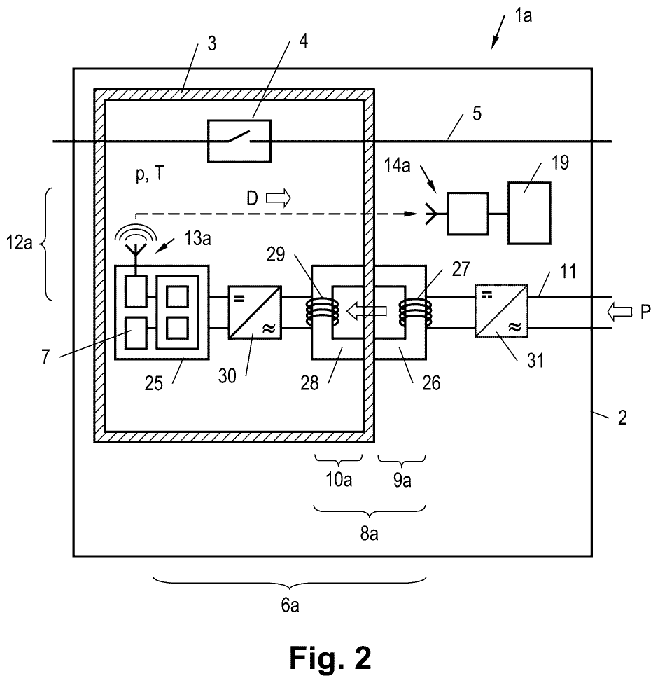

FIG. 2 shows another example of a switchgear 1a with an arrangement 6a, which is similar to the switchgear 1 and the arrangement 6 of FIG. 1, wherein the power transmitter 9a is designed as electromagnetic power transmitter and the power receiver 10a is designed as electromagnetic power receiver, wherein the electrically non-conductive form of power is electromagnetic power and wherein the electromagnetic power transmitter 9a and the electromagnetic power receiver 10a are electromagnetically coupled. The electromagnetic power transmitter 9a and the electromagnetic power receiver 10a form an electromagnetic contactless power transmission system 8a in this example.

In particular, like this is the case in FIG. 2, the electromagnetic power transmitter 9a can comprise a power transmitter primary magnetic core 26 and a primary power coil 27 wound around the power transmitter primary core 26, and the electromagnetic power receiver 10a can comprise a power transmitter secondary magnetic core 28 and a secondary power coil 29 wound around the power transmitter secondary magnetic core 28. In this embodiment, the electromagnetic contactless power transmission system 8a basically is embodied as a transformer, which is a well suited device to transmit electric power P in a contactless way. In this example, the sensing unit 25 and hence the electronic sensor 7 are connected to the secondary power coil 29 via a rectifier 30. The primary power coil 27 can directly be powered by an alternating voltage fed over the second power lines 11 or can be powered by an optional power converter 31, which converts an alternating voltage fed over the second power lines 11 into another suitable voltage. For example, the optional power converter 31 can be used if the frequency of the alternating voltage on the second power lines 11 does not fit to the electromagnetic contactless power transmission system 8a.

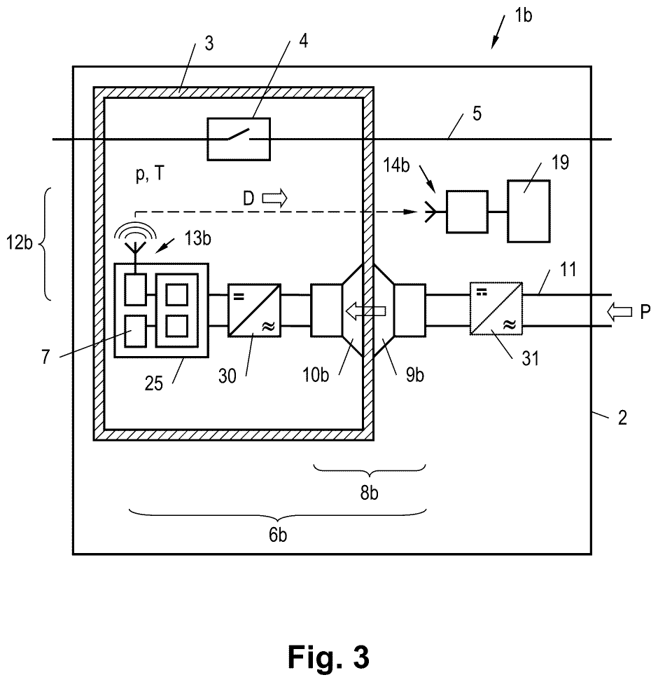

FIG. 3 now shows an example of a switchgear 1b with an arrangement 6b, which is similar to the switchgear 1a and the arrangement 6a of FIG. 2. Instead of an electromagnetic contactless power transmission system 8a, the arrangement 6b comprises an acoustic contactless power transmission system 8b. In detail, the power transmitter 9 is designed as an acoustic power transmitter (or sound emitter) 9b, and the power receiver 10 is designed as acoustic power receiver (or sound receiver) 10b. Accordingly, the electrically non-conductive form of power is acoustic power, and the acoustic power transmitter 9b and the acoustic power receiver 10b are acoustically coupled. Advantageously, an acoustic contactless power transmission system 8b is well suitable for tank systems 2 made of steel and in particular mild steel because no electromagnetic fields, which could be influenced by the material of the tank system 2, are involved in power transmission. Again, an optional power converter 31 can be used if the alternating voltage fed over the second power lines 11 is not directly be usable for the acoustic contactless power transmission system 8b. Acoustic power transmission can take place in the audible frequency range or advantageously in the ultrasonic frequency range. The latter provides power transmission without generation and emission of disturbing audible noise.

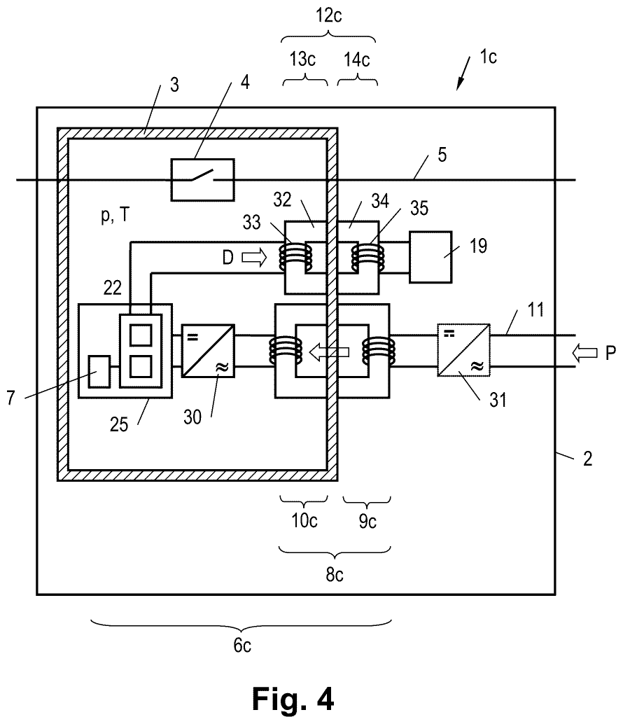

FIG. 4 shows an example of a switchgear 1c with an arrangement 6c, which is similar to the switchgear 1a and the arrangement 6a of FIG. 2. Instead of the radio data transmission system, the arrangement 6c comprises an electromagnetic contactless data transmission system 12c. In this embodiment, the data transmitter 13c is an electromagnetic data transmitter, and the data receiver 14c is an electromagnetic data receiver, wherein the electromagnetic data transmitter 13c and the electromagnetic data receiver 14c are electromagnetically coupled.

In detail, the electromagnetic data transmitter 13c can comprise a data transmitter primary magnetic core 32 and a primary data coil 33 wound around the data transmitter primary magnetic core 32. Moreover, the electromagnetic power receiver 14c can comprise a data transmitter secondary magnetic core 34 and a secondary data coil 35 wound around the data transmitter secondary magnetic core 34, wherein the microcontroller output 22 is connected to the secondary data coil 35.

The microcontroller 20 can gather measurement data D from the electronic sensor 7 which then is passed to the primary data coil 33, again either with previous processing of the measurement data D or without such processing. Like this was explained for the example in FIG. 1, the microcontroller 20 may also store measurement data D in the memory 24. Once the measurement data D is sent via the contactless data transmission system 12c, the measurement data D can further be processed in the evaluation unit 19 and/or sent to a superordinate control by wire or wirelessly. It should be noted that the arrangement 6c may also comprise a driver stage between the microcontroller output 22 and the primary data coil 33 if the microcontroller 20 cannot directly drive the primary data coil 33.

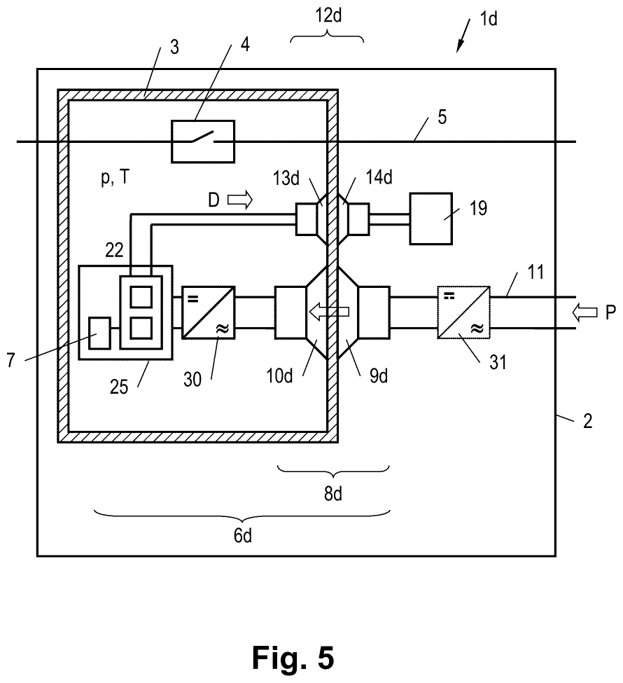

FIG. 5 shows another example of a switchgear 1d with an arrangement 6d, which is similar to the switchgear 1b and the arrangement 6b of FIG. 3. Instead of the radio data transmission system, the arrangement 6d comprises an acoustic contactless data transmission system 12d. In this embodiment, the data transmitter 13d is an acoustic data transmitter (or sound emitter), and the data receiver 14d is an acoustic data receiver (or sound receiver), wherein the acoustic data transmitter 13d and the acoustic data receiver 14d are acoustically coupled. Advantageously, an acoustic contactless data transmission system 12d is well suitable for tank systems 2 made of steel and in particular mild steel because no electromagnetic fields, which could be influenced by the material of the tank system 2, are involved in data transmission. Acoustic data transmission can take place in the audible frequency range or advantageously in the ultrasonic frequency range. The latter provides data transmission without generation and emission of disturbing audible noise.

Gathering measurement data D from the electronic sensor 7, optional preprocessing and outputting measurement data D via the microcontroller output 22 takes place like in the previous examples. The same counts for processing the measurement data D by the evaluation unit 19. Further on, the arrangement 6d may also comprise a driver stage between the microcontroller output 22 and the data transmitter 13d if the microcontroller 20 cannot directly drive the data transmitter 13d.

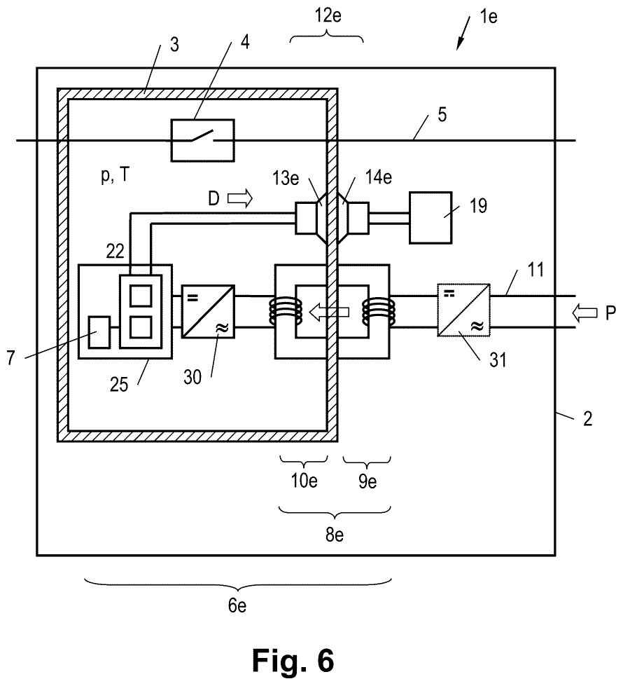

FIG. 6 shows a further example of a switchgear 1e with an arrangement 6e, which can be seen as mix of the switchgear 1c and the arrangement 6c of FIG. 4 and the switchgear 1d and the arrangement 6d of FIG. 5. Instead of the electromagnetic contactless data transmission system 12c, the arrangement 6e like the arrangement 6d of FIG. 5 comprises an acoustic contactless data transmission system 12e. In FIG. 6, there is an electromagnetic contactless power transmission system 8e and an acoustic contactless data transmission system 12e. However, roles may change and the switchgear 1e may also comprise an acoustic contactless power transmission system 8d like in FIG. 5 and an electromagnetic data transmission system 12e like in FIG. 4.

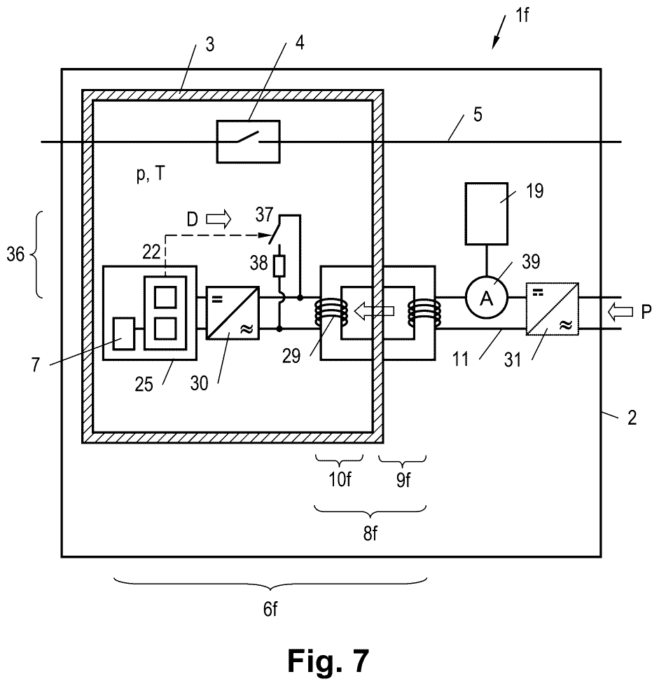

FIG. 7 now shows an example of a switchgear 1f with an arrangement 6f, which is similar to the switchgear 1a and the arrangement 6a of FIG. 2 (and also similar to FIGS. 5 and 6). Instead of the radio data transmission system, the arrangement 6f comprises load modulation means 36, which are connected to the electromagnetic power receiver 10f.

In this embodiment, the load modulation means 36 comprise a series connection of a modulation switch 37 and a resistor 38, wherein said series connection is connected in parallel with the secondary power coil 29. The microcontroller output 22 is connected to the load modulation means 36, in particular to the modulation switch 37. Hence, the modulation switch 37 is controlled by the microcontroller 20. Further on, the microcontroller 20, which is connected to the electronic sensor 7 and which receives measurement data D from the electronic sensor 7 via its microcontroller input 21, sends measurement data D to the load modulation means 36 via its microcontroller output 22. Concretely, the modulation switch 37 can be switched on and off in accordance with binary signals representing the measurement data D of the electronic sensor 7.

Furthermore, the arrangement 6f comprises current sensing means 39 connected to the electromagnetic power transmitter 9f. In detail, the current sensing means 39 measure the current in the second power lines 11. Said current varies in accordance with the modulation of the load at the secondary power coil 29, i.e. in accordance with the switching state of the modulation switch 37. Because the modulation switch 37 is be switched on and off in accordance with the measurement data D of the electronic sensor 7, also the current in the second power lines 11 represents said measurement data D. In this way, the current sensing means 39 are designed to receive measurement data D from the electromagnetic power receiver 10f. In this embodiment, the evaluation unit 19 is connected to the current sensing means 39 to postprocess the measurement data D.

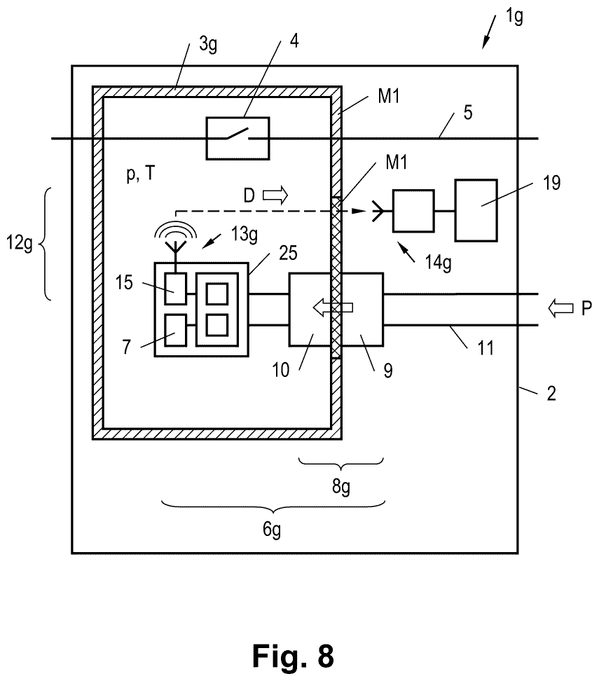

Generally, as already mentioned, the tank system 13 can be made of or can comprise stainless steel or mild steel. In an advantageous embodiment, the tank system 13 can be made of plastics in the region of the contactless power transmission system 8 and/or in the region of the optional contactless data transmission system 12 like this is depicted in FIG. 8. In detail, FIG. 8 shows an example of a switchgear 1g with an arrangement 6g, which is similar to the switchgear 1 and the arrangement 6 of FIG. 1. In contrast, the tank system 3g is made of metal M1 (e.g. stainless steel or mild steel) and comprises a portion made of plastics M2 in the region of the contactless power transmission system 8g and in the region of the optional contactless data transmission system 12g. The proposed measures help to increase efficiency of the electromagnetic contactless power transmission system 8a, 8c, 8e, 8f, 8g and/or the optional electromagnetic contactless data transmission system 12c because plastics are almost “invisible” for electromagnetic power and/or data coupling, meaning that plastics do not substantially attenuate electromagnetic transmission. The very same counts for radio data transmission systems 12, 12a, 12b, 12g. However, advantages may also result when acoustic contactless power transmission systems 8b, 8d and/or the optional acoustic contactless data transmission systems 12d, 12e are used because plastics usually are substantially softer than metals what supports efficient transmission of acoustic energy through the wall of the tank system 2 as well.

It is noted that the presently disclosed subject matter is not limited to the embodiments disclosed hereinbefore, but combinations of the different variants are possible. In reality, the system may have more or less parts than shown in the figures. Moreover, the description may comprise subject matter of further independent inventions.

It should also be noted that the term “comprising” does not exclude other elements and the use of articles “a” or “an” does not exclude a plurality. Also elements described in association with different embodiments may be combined. It should also be noted that reference signs in the claims should not be construed as limiting the scope of the claims.

### LIST OF REFERENCE NUMERALS

1, 1a . . . 1g switchgear
2 switchgear housing
3, 3g tank system
4 switching device
5 first power lines
6, 6a . . . 6g arrangement
7 electronic sensor
8, 8a . . . 8g contactless power transmission system
9, 9a . . . 9g power transmitter
10, 10a . . . 10g power receiver
11 second power lines
12, 12a . . . 12g contactless data transmission system
13, 13a . . . 13g data transmitter
14, 14a . . . 14g data receiver
15 radio data transmitter
16 transmitter antenna
17 radio data receiver
18 receiver antenna
19 evaluation unit
20 microcontroller
21 microcontroller input
22 microcontroller output
23 microprocessor
24 memory
25 sensing unit
26 power transmitter primary magnetic core
27 primary power coil
28 power transmitter secondary magnetic core
29 secondary power coil
30 rectifier
31 power converter
32 data transmitter primary magnetic core
33 primary data coil
34 data transmitter secondary magnetic core
35 secondary data coil
36 load modulation means
37 modulation switch
38 resistor
39 current sensing means
M1 metal
M2 plastics
D measurement data
P (electric) power
p pressure
T temperature

1. A Switchgear, comprising a tank system filled with an insulating gas and comprising a switching device and at least one electronic sensor within the tank system,
a contactless power transmission system with an electromagnetic power transmitter outside of the tank system and with an electromagnetic power receiver within the tank system, wherein
the electromagnetic power transmitter is designed to receive electric power (P) from a power source and to convert it into an electrically non-conductive form of power,
the electromagnetic power receiver is coupled to the power electromagnetic transmitter and designed to receive the electrically non-conductive form of power from the power transmitter and designed to convert it into electric power (P),
the power receiver is electrically connected to the electronic sensor (7) and designed to supply electric power (P) to the same,
load modulation means connected to the electromagnetic power receiver,
current sensing means connected to the electromagnetic power transmitter,
a microcontroller with a microcontroller input and a microcontroller output,
wherein the microcontroller is connected to the electronic sensor and designed to receive measurement data from the electronic sensor via its microcontroller input,
wherein the microcontroller output is connected to the load modulation means and wherein the microcontroller is designed to send measurement data to the load modulation means via its microcontroller output, and
wherein the current sensing means are designed to receive measurement data from the electromagnetic power receiver.

2. The Switchgear as claimed in claim 1, wherein
the electrically non-conductive form of power is electromagnetic power and
the electromagnetic power transmitter and the electromagnetic power receiver are electromagnetically coupled.

3. The Switchgear as claimed in claim 2, wherein
the electromagnetic power transmitter comprises a power transmitter primary magnetic core and a primary power coil wound around the power transmitter primary core,
the electromagnetic power receiver comprises a power transmitter secondary magnetic core and a secondary power coil wound around the power transmitter secondary magnetic core, wherein
the electronic sensor is connected to the secondary power coil.

4. (canceled)

5. The Switchgear as claimed in claim 1, wherein the at least one electronic sensor is designed to measure pressure (p) and/or temperature (T).

6. (canceled)

7. (canceled)

8. (canceled)

9. (canceled)

10. (canceled)

11. (canceled)

12. (canceled)

13. (canceled)

14. The Switchgear as claimed in of claim 1, wherein the tank system is made of or comprises stainless steel or mild steel.

15. The Switchgear as claimed in claim 5, wherein the tank system is made of plastics (M2) in the region of the contactless power transmission system.
